(19) United States
(12) Patent Application Publication
(10) Pub. No.: US 2023/0376772 A1
(43) Pub. Date: Nov. 23, 2023

(54) METHOD AND SYSTEM FOR APPLICATION PERFORMANCE MONITORING THRESHOLD MANAGEMENT THROUGH DEEP LEARNING MODEL

(71) Applicant: JPMorgan Chase Bank, N.A., New York, NY (US)

(72) Inventors: Gauraw TRIPATHY, Hyderabad (IN); Sachin GARAJKAR, Hyderabad (IN); Ranjith NERANDLA, Hyderabad (IN); Noor KHAN, Hyderabad (IN); Kishore PATEL, Thane (West) (IN); Priti KUMARI, Bengaluru (IN); Rajesh KUMAR, Bangalore (IN); Carlos POLO, League City, TX (US)

(73) Assignee: JPMorgan Chase Bank, N.A., New York, NY (US)

(21) Appl. No.: 18/195,626

(22) Filed: May 10, 2023

(30) Foreign Application Priority Data
May 19, 2022 (IN) 202211028793

(51) Int. Cl. G06N 3/084

(52) U.S. Cl. CPC G06N 3/084

(57) ABSTRACT

A method for facilitating automated application performance monitoring threshold management through deep learning model is provided. The method includes retrieving, via an application programming interface, raw data that correspond to an application, the raw data including application performance data; generating data frames based on the raw data, the data frames relating to a multi-dimensional data structure; converting the data frames into a model; developing an error function that optimizes a regression coefficient; training the model by using the error function; and determining, by using the trained model, forecasted threshold values that relate to application performance metrics for the application.

### CROSS-REFERENCE TO RELATED APPLICATIONS

This application claims the benefit of Indian Provisional Patent Application Serial No. 202211028793, filed May 19, 2022, which is hereby incorporated by reference in its entirety.

### BACKGROUND

### 1. Field of the Disclosure

This technology generally relates to methods and systems for managing application monitoring thresholds, and more particularly to methods and systems for facilitating automated application performance monitoring threshold management through deep learning model.

### 2. Background Information

Many business entities operate vast enterprise networks of various applications to provide services for users. Often, the efficiency of application performance monitoring depends on corresponding performance thresholds. Historically, conventional application threshold management techniques rely on biased interpretations of application performance data. Implementations of the conventional application threshold management techniques have resulted in varying degrees of success with respect to maintaining consistent application performance.

One drawback of using the conventional application threshold management techniques is that in many instances, the biased interpretations are vulnerable to false positives which eventually lead to false negatives. As a result, application performance may be degraded culminating in increased risks of financial loss and regulatory noncompliance. Additionally, new application performance data are not easily accounted for because the conventional application threshold management techniques are not continuous programmatic processes.

Therefore, there is a need for an artificial intelligence solution which uses a deep learning model to facilitate application performance threshold management by automatically forecasting performance threshold values at continuous time intervals.

### SUMMARY

The present disclosure, through one or more of its various aspects, embodiments, and/or specific features or sub-components, provides, inter alia, various systems, servers, devices, methods, media, programs, and platforms for facilitating automated application performance monitoring threshold management through deep learning model.

According to an aspect of the present disclosure, a method for facilitating automated application performance monitoring threshold management through deep learning model is disclosed. The method is implemented by at least one processor. The method may include retrieving, via an application programming interface, raw data that correspond to at least one application, the raw data may include application performance data; generating at least one data frame based on the raw data, the at least one data frame may relate to a multi-dimensional data structure; converting the at least one data frame into at least one model; developing at least one error function that optimizes a regression coefficient; training the at least one model by using the at least one error function; and determining, by using the trained at least one model, at least one forecasted threshold value that relates to at least one application performance metric for the at least one application.

In accordance with an exemplary embodiment, the at least one model may relate to a relationship between at least one independent feature and at least one dependent feature of the application performance data.

In accordance with an exemplary embodiment, the training may include a recurrent training process that minimizes the at least one error function, the recurrent training process may include a plurality of computing layers of neural networks.

In accordance with an exemplary embodiment, the plurality of computing layers may include at least one memory cell that persists learning acquired from a relationship between at least one independent feature and at least one dependent feature of the application performance data.

In accordance with an exemplary embodiment, the plurality of computing layers may include a second layer that uses a first output from a first layer to compute at least one partial derivative and update a model parameter, a third layer that trains a second output from the second layer by recomputing the model parameter with a new set of parameters, and a fourth layer that trains a third output from the third layer until the at least one error function converges to a minimum value.

In accordance with an exemplary embodiment, the at least one forecasted threshold value may be automatically determined for the at least one application according to a time interval, the time interval may include a period of time that is dynamically adjusted based on time series data.

In accordance with an exemplary embodiment, to retrieve the raw data, the method may further include generating at least one access token for each of a plurality of access calls that corresponds to the application programming interface; passing the at least one access token together with the plurality of access calls to the application programming interface, the plurality of access calls may include a predetermined expiration time and a set of parameters; and retrieving, via the application programming interface, the raw data from at least one application performance monitoring toolset.

In accordance with an exemplary embodiment, the raw data may include at least one application performance metric and an associated hardware performance metric, the at least one application performance metric may include an application latency metric.

In accordance with an exemplary embodiment, the at least one model may include at least one from among a machine learning model, a statistical model, a mathematical model, a process model, and a data model.

According to an aspect of the present disclosure, a computing device configured to implement an execution of a method for facilitating automated application performance monitoring threshold management through deep learning model is disclosed. The computing device including a processor; a memory; and a communication interface coupled to each of the processor and the memory, wherein the processor may be configured to retrieve, via an application programming interface, raw data that correspond to at least one application, the raw data may include application performance data; generate at least one data frame based on the raw data, the at least one data frame may relate to a multi-dimensional data structure; convert the at least one data frame into at least one model; develop at least one error function that optimizes a regression coefficient; train the at least one model by using the at least one error function; and determine, by using the trained at least one model, at least one forecasted threshold value that relates to at least one application performance metric for the at least one application.

In accordance with an exemplary embodiment, the at least one model may relate to a relationship between at least one independent feature and at least one dependent feature of the application performance data.

In accordance with an exemplary embodiment, the training may include a recurrent training process that minimizes the at least one error function, the recurrent training process may include a plurality of computing layers of neural networks.

In accordance with an exemplary embodiment, the plurality of computing layers may include at least one memory cell that persists learning acquired from a relationship between at least one independent feature and at least one dependent feature of the application performance data.

In accordance with an exemplary embodiment, the plurality of computing layers may include a second layer that uses a first output from a first layer to compute at least one partial derivative and update a model parameter, a third layer that trains a second output from the second layer by recomputing the model parameter with a new set of parameters, and a fourth layer that trains a third output from the third layer until the at least one error function converges to a minimum value.

In accordance with an exemplary embodiment, the processor may be further configured to automatically determine the at least one forecasted threshold value for the at least one application according to a time interval, the time interval may include a period of time that is dynamically adjusted based on time series data.

In accordance with an exemplary embodiment, to retrieve the raw data, the processor may be further configured to generate at least one access token for each of a plurality of access calls that corresponds to the application programming interface; pass the at least one access token together with the plurality of access calls to the application programming interface, the plurality of access calls may include a predetermined expiration time and a set of parameters; and retrieve, via the application programming interface, the raw data from at least one application performance monitoring toolset.

In accordance with an exemplary embodiment, the raw data may include at least one application performance metric and an associated hardware performance metric, the at least one application performance metric may include an application latency metric.

In accordance with an exemplary embodiment, the at least one model may include at least one from among a machine learning model, a statistical model, a mathematical model, a process model, and a data model.

According to an aspect of the present disclosure, a non-transitory computer readable storage medium storing instructions for facilitating automated application performance monitoring threshold management through deep learning model is disclosed. The storage medium including executable code which, when executed by a processor, may cause the processor to retrieve, via an application programming interface, raw data that correspond to at least one application, the raw data may include application performance data; generate at least one data frame based on the raw data, the at least one data frame may relate to a multi-dimensional data structure; convert the at least one data frame into at least one model; develop at least one error function that optimizes a regression coefficient; train the at least one model by using the at least one error function; and determine, by using the trained at least one model, at least one forecasted threshold value that relates to at least one application performance metric for the at least one application.

In accordance with an exemplary embodiment, the training may include a recurrent training process that minimizes the at least one error function, the recurrent training process may include a plurality of computing layers of neural networks.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating automated application performance monitoring threshold management through deep learning model.

FIG. 4 is a flowchart of an exemplary process for implementing a method for facilitating automated application performance monitoring threshold management through deep learning model.

FIG. 5 is a flow diagram of an exemplary process for implementing a method for facilitating automated application performance monitoring threshold management through deep learning model.

FIG. 6 is a flow diagram of memory cells that facilitates an exemplary process for implementing a method for facilitating automated application performance monitoring threshold management through deep learning model.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

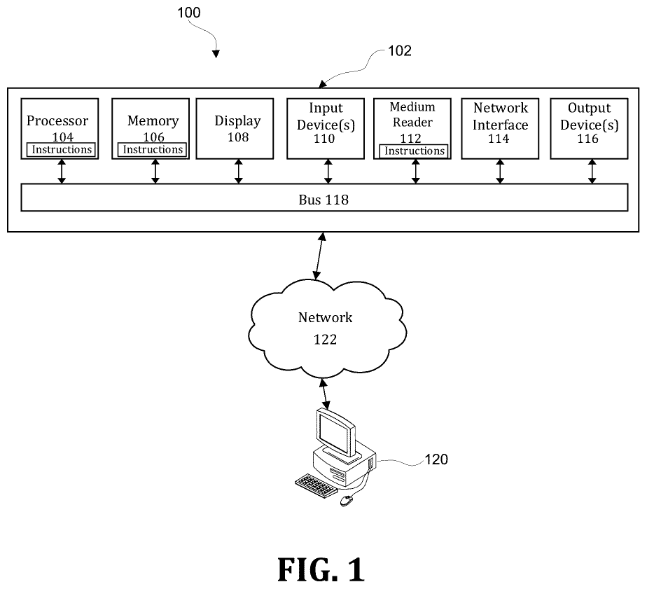

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons of skill in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating automated application performance monitoring threshold management through deep learning model.

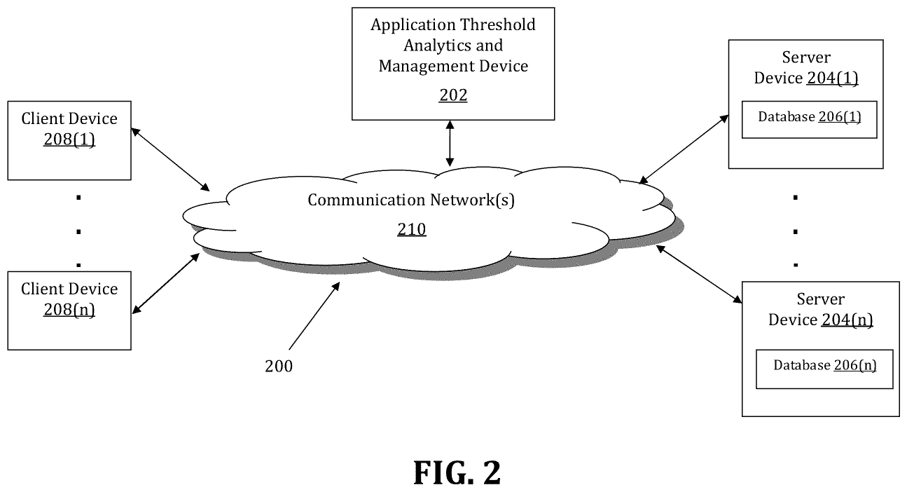

Referring to FIG. 2, a schematic of an exemplary network environment 200 for implementing a method for facilitating automated application performance monitoring threshold management through deep learning model is illustrated. In an exemplary embodiment, the method is executable on any networked computer platform, such as, for example, a personal computer (PC).

The method for facilitating automated application performance monitoring threshold management through deep learning model may be implemented by an Application Threshold Analytics and Management (ATAM) device 202. The ATAM device 202 may be the same or similar to the computer system 102 as described with respect to FIG. 1. The ATAM device 202 may store one or more applications that can include executable instructions that, when executed by the ATAM device 202, cause the ATAM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ATAM device 202 itself, may be located in virtual server(s) running in a cloud-based computing environment rather than being tied to one or more specific physical network computing devices. Also, the application(s) may be running in one or more virtual machines (VMs) executing on the ATAM device 202. Additionally, in one or more embodiments of this technology, virtual machine(s) running on the ATAM device 202 may be managed or supervised by a hypervisor.

In the network environment 200 of FIG. 2, the ATAM device 202 is coupled to a plurality of server devices 204(1)-204(n) that hosts a plurality of databases 206(1)-206(n), and also to a plurality of client devices 208(1)-208(n) via communication network(s) 210. A communication interface of the ATAM device 202, such as the network interface 114 of the computer system 102 of FIG. 1, operatively couples and communicates between the ATAM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ATAM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ATAM devices that efficiently implement a method for facilitating automated application performance monitoring threshold management through deep learning model.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ATAM device 202 may be a standalone device or integrated with one or more other devices or apparatuses, such as one or more of the server devices 204(1)-204(n), for example. In one particular example, the ATAM device 202 may include or be hosted by one of the server devices 204(1)-204(n), and other arrangements are also possible. Moreover, one or more of the devices of the ATAM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ATAM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to raw data, application performance data, data frames, multi-dimensional data structures, data models, error functions, regression coefficients, forecasted threshold values, and application performance metrics.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ATAM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ATAM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ATAM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ATAM device 202, the server devices 204(1)-204(n), or the client devices 208(1)-208(n), for example, may be configured to operate as virtual instances on the same physical machine. In other words, one or more of the ATAM device 202, the server devices 204(1)-204(n), or the client devices 208(1)-208(n) may operate on the same physical device rather than as separate devices communicating through communication network(s) 210. Additionally, there may be more or fewer ATAM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

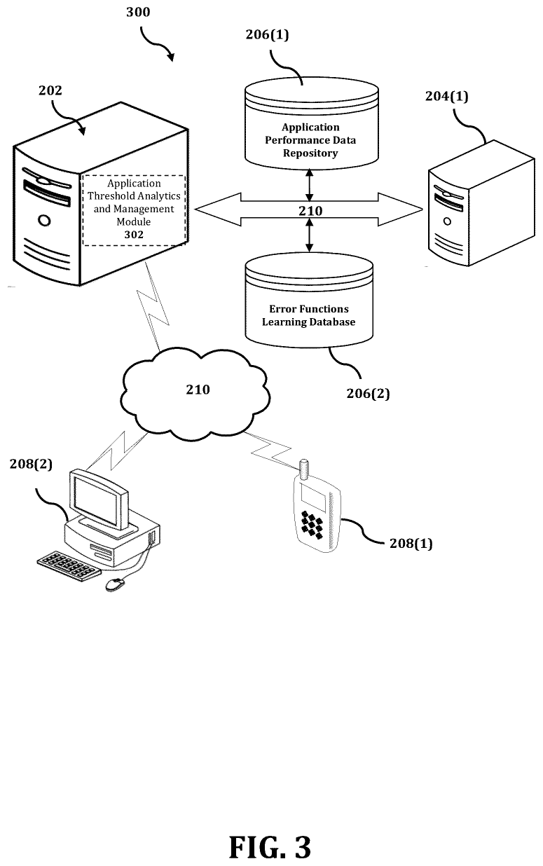

The ATAM device 202 is described and shown in FIG. 3 as including an application threshold analytics and management module 302, although it may include other rules, policies, modules, databases, or applications, for example. As will be described below, the application threshold analytics and management module 302 is configured to implement a method for facilitating automated application performance monitoring threshold management through deep learning model.

An exemplary process 300 for implementing a mechanism for facilitating automated application performance monitoring threshold management through deep learning model by utilizing the network environment of FIG. 2 is shown as being executed in FIG. 3. Specifically, a first client device 208(1) and a second client device 208(2) are illustrated as being in communication with ATAM device 202. In this regard, the first client device 208(1) and the second client device 208(2) may be “clients” of the ATAM device 202 and are described herein as such. Nevertheless, it is to be known and understood that the first client device 208(1) and/or the second client device 208(2) need not necessarily be “clients” of the ATAM device 202, or any entity described in association therewith herein. Any additional or alternative relationship may exist between either or both of the first client device 208(1) and the second client device 208(2) and the ATAM device 202, or no relationship may exist.

Further, ATAM device 202 is illustrated as being able to access an application performance data repository 206(1) and an error function learning database 206(2). The application threshold analytics and management module 302 may be configured to access these databases for implementing a method for facilitating automated application performance monitoring threshold management through deep learning model.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ATAM device 202 via broadband or cellular communication. Of course, these embodiments are merely exemplary and are not limiting or exhaustive.

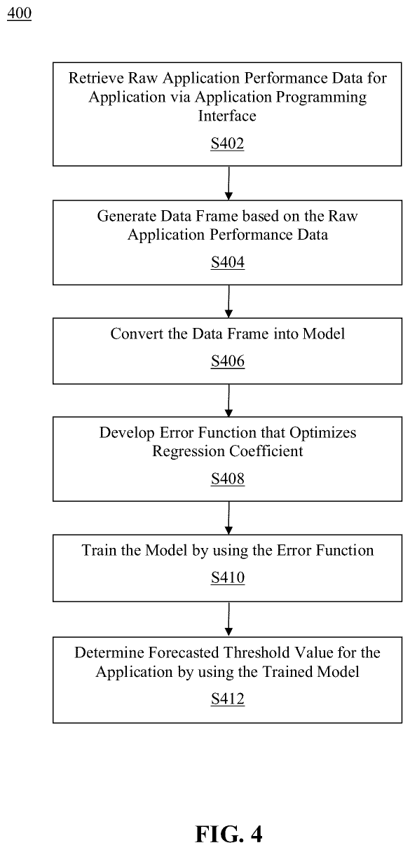

Upon being started, the application threshold analytics and management module 302 executes a process for facilitating automated application performance monitoring threshold management through deep learning model. An exemplary process for facilitating automated application performance monitoring threshold management through deep learning model is generally indicated at flowchart 400 in FIG. 4.

In the process 400 of FIG. 4, at step S402, raw data that correspond to an application may be retrieved via an application programming interface (API). The raw data may include application performance data. In an exemplary embodiment, the raw data may include primary data such as, for example, toolset data that are collected from a source such as, for example, a performance monitoring toolset. The raw data may be retrieved from the source with additional processing as a structured data set as well as retrieved from the source without additional processing as an unstructured data set. Consistent with present disclosures, the raw data may include any combination of alphabetical characters, numerical characters, and symbols in any format.

In another exemplary embodiment, the API may include an interface that corresponds to a software intermediary. The software intermediary may facilitate communication between various computing components by defining rules and expectations for the communication. In another exemplary embodiment, the API may include a set of programming code that enables communication between the various computing components. The set of programming code may include a set of definitions and protocols that allow products and services to communicate with other products and services without specific implementation knowledge.

In another exemplary embodiment, the raw data may be retrieved recurrently via a secured API. As most application performance monitoring toolsets relate to third-party products, programmatic API led data sourcing may require an industry accepted authentication and authorization framework. The authentication and authorization framework may be developed to build a secure API connection to source the data.

In another exemplary embodiment, the authentication and authorization framework may assign an identifier such as, for example, a universally unique identifier to newly generated API client identities. When code is initiated for the newly generated API client identities, an access token may be generated for each API access call. In another exemplary embodiment, the API access call may include a defined expiration time after which a set of required parameters are passed to a corresponding API to retrieve the data. The in-progress data procurement process may terminate once the data is retrieved thereby enabling the sourcing of data such as, for example, application performance data in a recurrent process.

In another exemplary embodiment, the application performance data may include information that indicates how the application is functioning and how responsive the application is to the end-user. The application performance data may be measured by using application performance monitoring toolsets that track various application performance metrics such as, for example, application latency as well as associated hardware performance metrics. The application performance monitoring toolsets may correspond to first-party software as well as third-party software.

In another exemplary embodiment, the application may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, a data frame may be generated based on the raw data. The data frame may relate to a multi-dimensional data structure. In an exemplary embodiment, raw data such as, for example, raw application performance data may be manipulated into the data frame. The data frame may relate to a two-dimensional or three-dimensional structure similar to a matrix. In another exemplary embodiment, the size of the matrix may be mutable, and the matrix may include columns of different types. Arithmetic operations may be performed on the rows and columns, which may each be labelled.

In another exemplary embodiment, independent features in the application performance data may be scaled to achieve values around a corresponding mean value with a unit standard deviation. The scaling may necessarily indicate that the mean value of attributes of the independent features becomes zero and the resultant distribution has a unit standard deviation. The corresponding mathematical expression may be represented as:

X′=X−μ/sigma,

where “X” is the mean of the feature value and “sigma” is the standard deviation of the feature value. The scaled data frame may relate to a training data frame that is ingestible by a neural network.

In another exemplary embodiment, the neural network may include various computing layers such as, for example, an input layer and subsequent processing layers. The layers of the neural network may be configured such that output of predecessor layers become input for successor layers. In another exemplary embodiment the layers such as, for example, the input layer may include a memory cell that persists learning acquired from the relationship between independent and dependent features of the application performance data.

At step S406, the data frame may be converted into a model. The model may relate to a data model that represents relationships between independent features and dependent features of the application performance data.

In an exemplary embodiment, the data frame may be converted into a model by using an input layer of a neural network. In the input layer, the scaled application performance data frame may be converted into a function such as, for example, the model that represents the relationship between the independent and dependent features of the application performance data. The corresponding mathematical expression may be represented as:

Y=ƒ(x)=⊖0+⊖1*x,

where ⊖0 and ⊖1 are regression coefficients.

When the application performance data set includes two or more independent variables, the corresponding mathematical expression may be represented as:

Y=ƒ(x)=Σj=0⊖j*xj,

where xj is feature and ⊖j is model parameter.

The conversion of the data frame into the above functions may be achieved by a set of neurons that perform multiple mathematical operations.

In another exemplary embodiment, the model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, K-fold cross-validation analysis, balanced class weight analysis, etc. In another exemplary embodiment, machine learning analytical techniques may include unsupervised learning algorithms such as, for example, Apriori analysis, K-means clustering analysis, isolation forest analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S408, an error function that optimizes a regression coefficient may be developed. In an exemplary embodiment, the error function may be developed by a layer such as, for example, a first layer that is subsequent to the input layer. The first layer may develop the error function to optimize the regression coefficient to minimize the error and compute the partial derivative of the error function with respect to model parameter (⊖j). For example, in data frame <x1, x2, x3 . . . xj>, the corresponding mathematical expression may be represented as:

$$δ error function = \frac{1}{2 m} \sum mj = 1 ( h θ ( xj ) - yj ) ** 2 ,$$

where “m” is a number of samples.

Conversion of the data frame into the above function may be achieved by a set of neurons that performs multiple mathematical operations.

In another exemplary embodiment, the first layer may include memory cells that utilize the error function to learn the relationships between the independent and dependent features of the application performance data. The memory cells may also persist the learned relationships to enable the self-learning of the training data in a recurrent manner.

At step S410, the model may be trained by using the developed error function. In an exemplary embodiment, the training may include a recurrent training process that minimizes the error function. The recurrent training process may include a plurality of computing layers of neural networks.

In another exemplary embodiment, the plurality of computing layers that facilitate the recurrent training process may include a second layer, a third layer, and a fourth layer. As will be appreciated by a person of ordinary skill in the art, the plurality of computing layers that facilitate the recurrent training process may include any number of computing layers.

In another exemplary embodiment, for the second layer, the output function of the first layer may be used to compute the partial derivatives and update the model parameter (⊖j). The corresponding mathematical expression may be represented as:

$$θ j = θ j - α δ / δ θ j * \{ \frac{1}{m} \sum mj = 1 ( h θ ( xj ) - yj ) ** 2 \} ,$$

where α is the learning rate.

In another exemplary embodiment, for the third layer, the output of the second layer may be further trained by recomputing the ⊖j with a new set of parameters ⊖.

In another exemplary embodiment, for the fourth layer, the output of the third layer may be further trained until δ error function converges to a minimum value to provide the output layer the most accurate forecast value. The derived relationship may also be fed back to the first layer to facilitate recurrent learning from the error function. The derived relationship may correspond to relationships between the independent and dependent features of the application performance data. Consistent with present disclosures, the learning may be persisted in the first layer.

At step S412, a forecasted threshold value that relates to an application performance metric for the application may be determined by using the trained model. Consistent with present disclosures, the forecasted threshold value may be determined by the fourth layer for a subsequent output layer. In an exemplary embodiment, the forecasted threshold value may be automatically determined for the application according to a time interval. The time interval may include a period of time that is dynamically adjusted based on time series data. As will be appreciated by a person of ordinary skill in the art, the automatic determination of the forecasted threshold value according to a time interval may facilitate continuous application threshold management.

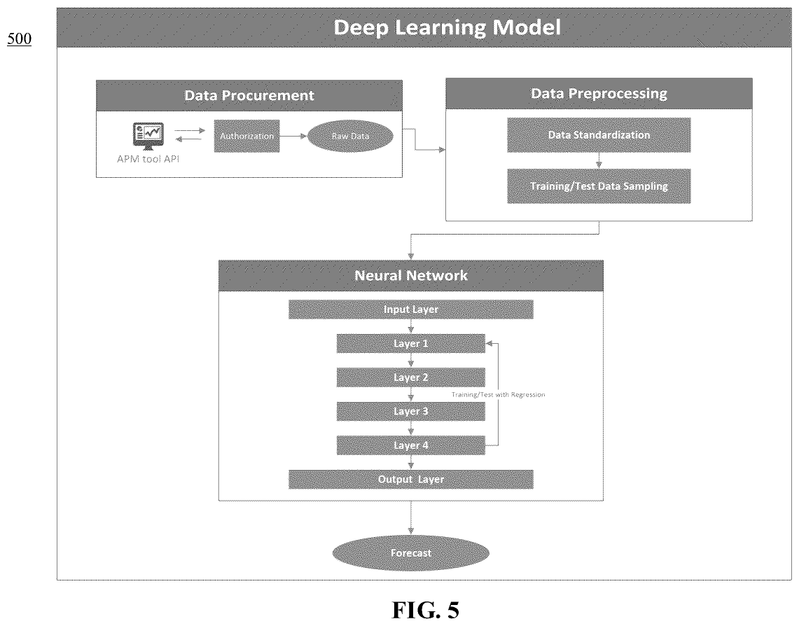

FIG. 5 is a flow diagram 500 of an exemplary process for implementing a method for facilitating automated application performance monitoring threshold management through deep learning model. Consistent with present disclosures, FIG. 5 provides a high-level design overview of the deep learning threshold management process.

As illustrated in FIG. 5, the deep learning threshold management process may procure application performance data through an API integrated pipeline, preprocess the data to remove data biases, and provide the preprocessed data to a neural network. Consistent with present disclosures, the neural network may include multiple layers. Each of the layers may perform a set of mathematical operations to eventually perform regression analysis. Subsequent layers may receive as input the output of the predecessor layer.

The layers may achieve data regression and train themselves by using the application performance data. The layers may be capable of remembering the relationship between the processed independent feature and dependent feature, thereby eliminating the need to store huge data populations. When new data is introduced to the model in a recurrent way, the model may append the new data to the stored learning to continuously improve the accuracy of the forecasted threshold.

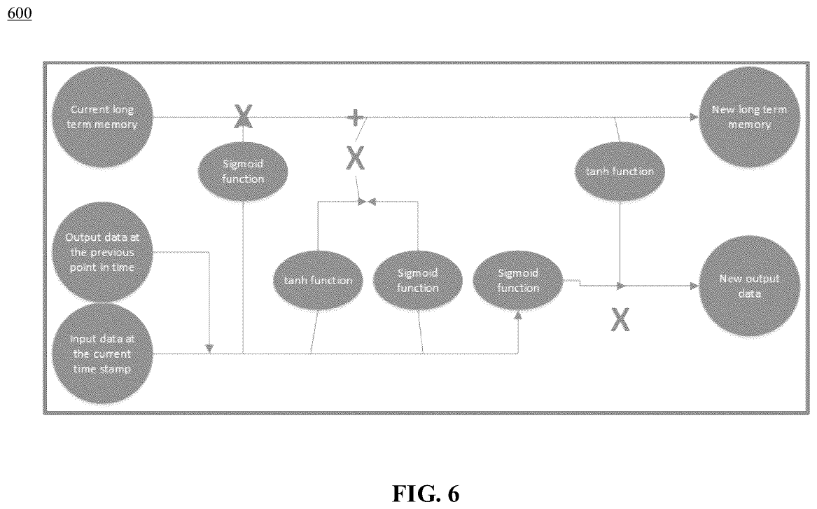

FIG. 6 is a flow diagram 600 of memory cells that facilitates an exemplary process for implementing a method for facilitating automated application performance monitoring threshold management through deep learning model. In FIG. 6, the memory cells of a layer such as, for example, layer one may be utilized to learn from the error function and persist the learning consistent with present disclosures.

As illustrated in FIG. 6, the memory cells may learn error function relationships between the independent and dependent features of the application performance data. The memory cells may utilize output data at the previous point in time and input data at the current time stamp together with various mathematical functions to provide new output data. In FIG. 6, “X” may represent pointwise multiplication and “+” may represent pointwise addition.

Accordingly, with this technology, an optimized process for facilitating automated application performance monitoring threshold management through deep learning model is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automated application performance monitoring threshold management through deep learning model, the method being implemented by at least one processor, the method comprising:
retrieving, by the at least one processor via an application programming interface, raw data that correspond to at least one application, the raw data including application performance data;
generating, by the at least one processor, at least one data frame based on the raw data, the at least one data frame relating to a multi-dimensional data structure;
converting, by the at least one processor, the at least one data frame into at least one model;
developing, by the at least one processor, at least one error function that optimizes a regression coefficient;
training, by the at least one processor, the at least one model by using the at least one error function; and
determining, by the at least one processor using the trained at least one model, at least one forecasted threshold value that relates to at least one application performance metric for the at least one application.

2. The method of claim 1, wherein the at least one model relates to a relationship between at least one independent feature and at least one dependent feature of the application performance data.

3. The method of claim 1, wherein the training includes a recurrent training process that minimizes the at least one error function, the recurrent training process including a plurality of computing layers of neural networks.

4. The method of claim 3, wherein the plurality of computing layers include at least one memory cell that persists learning acquired from a relationship between at least one independent feature and at least one dependent feature of the application performance data.

5. The method of claim 4, wherein the plurality of computing layers include a second layer that uses a first output from a first layer to compute at least one partial derivative and update a model parameter, a third layer that trains a second output from the second layer by recomputing the model parameter with a new set of parameters, and a fourth layer that trains a third output from the third layer until the at least one error function converges to a minimum value.

6. The method of claim 1, wherein the at least one forecasted threshold value is automatically determined for the at least one application according to a time interval, the time interval including a period of time that is dynamically adjusted based on time series data.

7. The method of claim 1, wherein retrieving the raw data further comprises:
generating, by the at least one processor, at least one access token for each of a plurality of access calls that corresponds to the application programming interface;
passing, by the at least one processor, the at least one access token together with the plurality of access calls to the application programming interface, the plurality of access calls including a predetermined expiration time and a set of parameters; and
retrieving, by the at least one processor via the application programming interface, the raw data from at least one application performance monitoring toolset.

8. The method of claim 7, wherein the raw data includes at least one application performance metric and an associated hardware performance metric, the at least one application performance metric including an application latency metric.

9. The method of claim 1, wherein the at least one model includes at least one from among a machine learning model, a statistical model, a mathematical model, a process model, and a data model.

10. A computing device configured to implement an execution of a method for facilitating automated application performance monitoring threshold management through deep learning model, the computing device comprising:
a processor;
a memory; and
a communication interface coupled to each of the processor and the memory,
wherein the processor is configured to:
retrieve, via an application programming interface, raw data that correspond to at least one application, the raw data including application performance data;
generate at least one data frame based on the raw data, the at least one data frame relating to a multi-dimensional data structure;
convert the at least one data frame into at least one model;
develop at least one error function that optimizes a regression coefficient;
train the at least one model by using the at least one error function; and
determine, by using the trained at least one model, at least one forecasted threshold value that relates to at least one application performance metric for the at least one application.

11. The computing device of claim 10, wherein the at least one model relates to a relationship between at least one independent feature and at least one dependent feature of the application performance data.

12. The computing device of claim 10, wherein the training includes a recurrent training process that minimizes the at least one error function, the recurrent training process including a plurality of computing layers of neural networks.

13. The computing device of claim 12, wherein the plurality of computing layers include at least one memory cell that persists learning acquired from a relationship between at least one independent feature and at least one dependent feature of the application performance data.

14. The computing device of claim 13, wherein the plurality of computing layers include a second layer that uses a first output from a first layer to compute at least one partial derivative and update a model parameter, a third layer that trains a second output from the second layer by recomputing the model parameter with a new set of parameters, and a fourth layer that trains a third output from the third layer until the at least one error function converges to a minimum value.

15. The computing device of claim 10, wherein the processor is further configured to automatically determine the at least one forecasted threshold value for the at least one application according to a time interval, the time interval including a period of time that is dynamically adjusted based on time series data.

16. The computing device of claim 10, wherein, to retrieve the raw data, the processor is further configured to:
generate at least one access token for each of a plurality of access calls that corresponds to the application programming interface;
pass the at least one access token together with the plurality of access calls to the application programming interface, the plurality of access calls including a predetermined expiration time and a set of parameters; and
retrieve, via the application programming interface, the raw data from at least one application performance monitoring toolset.

17. The computing device of claim 16, wherein the raw data includes at least one application performance metric and an associated hardware performance metric, the at least one application performance metric including an application latency metric.

18. The computing device of claim 10, wherein the at least one model includes at least one from among a machine learning model, a statistical model, a mathematical model, a process model, and a data model.

19. A non-transitory computer readable storage medium storing instructions for facilitating automated application performance monitoring threshold management through deep learning model, the storage medium comprising executable code which, when executed by a processor, causes the processor to:
retrieve, via an application programming interface, raw data that correspond to at least one application, the raw data including application performance data;
generate at least one data frame based on the raw data, the at least one data frame relating to a multi-dimensional data structure;
convert the at least one data frame into at least one model;
develop at least one error function that optimizes a regression coefficient;
train the at least one model by using the at least one error function; and
determine, by using the trained at least one model, at least one forecasted threshold value that relates to at least one application performance metric for the at least one application.

20. The storage medium of claim 19, wherein the training includes a recurrent training process that minimizes the at least one error function, the recurrent training process including a plurality of computing layers of neural networks.
